(19) United States
(12) Patent Application Publication
(10) Pub. No.: US 2022/0369579 A1
(43) Pub. Date: Nov. 24, 2022

(54) Current-Switching Unit of a Nozzle-Swinging Apparatus of a Sprinkler

(71) Applicant: Yuan Pin Industrial Co., Ltd., Ho-Mei Township (TW)

(72) Inventor: Ming-Chih Hsieh, Ho-Mei Township (TW)

(21) Appl. No.: 17/325,411

(22) Filed: May 20, 2021

(51) Int. Cl. A01G 25/16; B05B 1/30

(52) U.S. Cl. CPC A01G 25/165; B05B 1/3006

(57) ABSTRACT

A sprinkler includes a nozzle-swinging apparatus including a movable base and a current-switching unit. The movable base includes a partition between two chambers that contain a leafed wheel and a gear train. The partition includes two channels between the chambers. The current-switching unit includes two tabs, two connectors, a valve and a switch. The tabs extend toward the connectors in one of the chambers. The valve includes two pivots each of which extends in a gap between one of the tabs and one of the connectors. The switch includes a valve-moving element for grabbing the valve and a lever including a first section extending out of the movable base and a second section extending in the movable base. The first section of the lever is operable to pivot the second section of the lever so that the valve-moving element causes the valve to close one of the channels.

### BACKGROUND OF INVENTION

### 1. Field of Invention

The present invention relates to a sprinkler for gardening and, more particularly, to a current-switching unit of a nozzle-swinging apparatus of a sprinkler.

### 2. Related Prior Art

Referring to FIGS. 9 through 11, a conventional sprinkler 90 includes a nozzle 91, a joint 92 and a nozzle-swinging apparatus 80. The nozzle 91 is connected to an end of the nozzle-swinging apparatus 80 so that the nozzle 91 swings with the nozzle-swinging apparatus 80 in operation. The joint 92 is connected to another end of the nozzle-swinging apparatus 80. In use, the joint 92 is connected to a source such as faucet (not shown) via a hose (not shown) so that a current of water enters the nozzle-swinging apparatus 80 from the source via the hose in operation.

The nozzle-swinging apparatus 80 includes a movable base 81, a leafed wheel 82, a gear train 83 and a current-switching unit 84. The movable base 81 is a hollow element including two chambers 811 and 812, an entrance 813, an exit 814 and two channels 815 and 816. The chamber 812 is separated from the chamber 811. The chamber 812 is in communication with the exterior of the movable base 81 through the entrance 813. The chamber 811 is in communication with the exterior of the movable base 81 via the exit 814. The chamber 811 is in communication with the chamber 812 via the channels 815 and 816.

The leafed wheel 82 is pivotally located in the chamber 811. In use, the current of water goes through the channel 815 to rotate the leafed wheel 82 in a sense of direction or goes through the channel 816 to rotate the leafed wheel 82 in another sense of direction.

The gear train 83 is pivotally located in the gear chamber 811. The gear train 83 is operatively connected to the leafed wheel 82 so that the gear train 83 is driven by the leafed wheel 82. The gear train 83 rotates the movable base 81 relative to the joint 92.

The current-switching unit 84 includes a valve 841 and a switch 824. The valve 841 is formed with a cavity 8411. The valve 841 is pivotally located in the movable base 81 near the chamber 812, in the vicinity of the channels 815 and 816. The switch 842 includes a first section extending out of the cavity 8411 and a second section extending into the cavity 8411. The first section of the switch 842 extends out of the chamber 812. The first section of the switch 842 is operable to cause the second section of the switch 842 to abut against a wall of the cavity 8411 to drive the valve 841. Thus, the valve 841 selectively blocks the channel 815 or 816 to change the sense of direction of the current of water, which enters the chamber 811. However, it is quite difficult to drive the valve 841 because the cavity 8411 is made in the center of the valve 841. The difficulty of driving the valve 841 entails a challenge for the rigidity of the switch 842.

The present invention is therefore intended to obviate or at least alleviate the problems encountered in the prior art.

### SUMMARY OF INVENTION

It is the primary objective of the present invention to provide a sprinkler with robust efficient nozzle-swinging apparatus.

To achieve the foregoing objective, the nozzle-swinging apparatus includes a movable base and a current-switching unit. The movable base is located in the sprinkler and includes a partition between two chambers. The first chamber contains a leafed wheel. The second chamber contains a gear train. The partition includes two channels via which the first chamber is in communication with the second chamber. The current-switching unit includes two tabs, two connectors, a valve and a switch. The first tab extends in the second chamber from the partition. The second tab extends in the second chamber from the partition. The first connector extends toward the first tab in the second chamber. The second connector extends toward the second tab in the second chamber. The valve includes two pivots. The first pivot extends in a gap between the first tab and the first connector. The second pivot extends in a gap between the second tab and the second connector. The switch includes a lever and a valve-moving element. The lever includes a first section extending out of the movable base and a second section extending in the movable base. The valve-moving element grabs the valve. The first section of the lever is operable to pivot the second section of the lever so that the valve-moving element causes the valve to close one of the channels.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a nozzle-swinging apparatus for a sprinkler according to the preferred embodiment of the present invention;

FIG. 2 is a cross-sectional view of the nozzle-swinging apparatus shown in FIG. 1;

FIG. 3 is a cut-away view of the nozzle-swinging apparatus shown in FIG. 1;

FIG. 4 is an exploded view of the nozzle-swinging apparatus shown in FIG. 1;

FIG. 5 is a partial view of the nozzle-swinging apparatus shown in FIG. 4;

FIG. 6 is another partial view of the nozzle-swinging apparatus shown in FIG. 4;

FIG. 7 is another partial view of the nozzle-swinging apparatus shown in FIG. 4;

FIG. 8 is another cross-sectional view of the nozzle-swinging apparatus shown in FIG. 1;

FIG. 9 is a perspective view of a conventional sprinkler nozzle-swinging apparatus shown in FIG. 3;

FIG. 10 is a cross-sectional view of the sprinkler shown in FIG. 9; and

FIG. 11 is another cross-sectional view of the sprinkler of FIG. 9.

### DETAILED DESCRIPTION OF PREFERRED EMBODIMENT

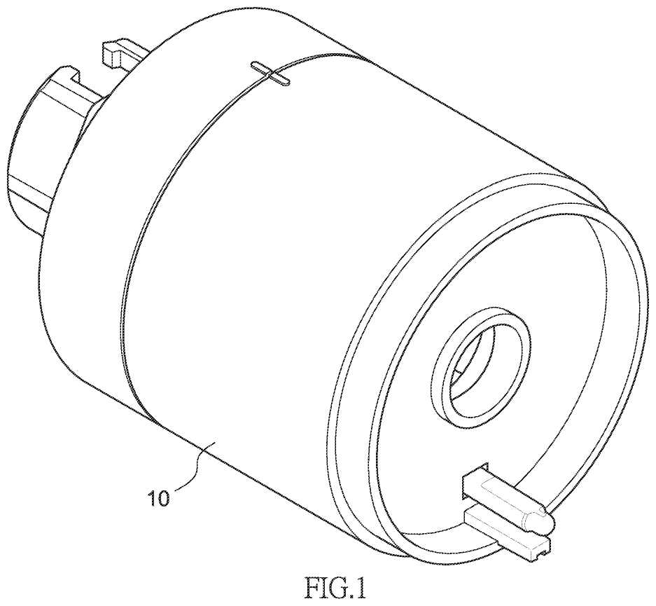

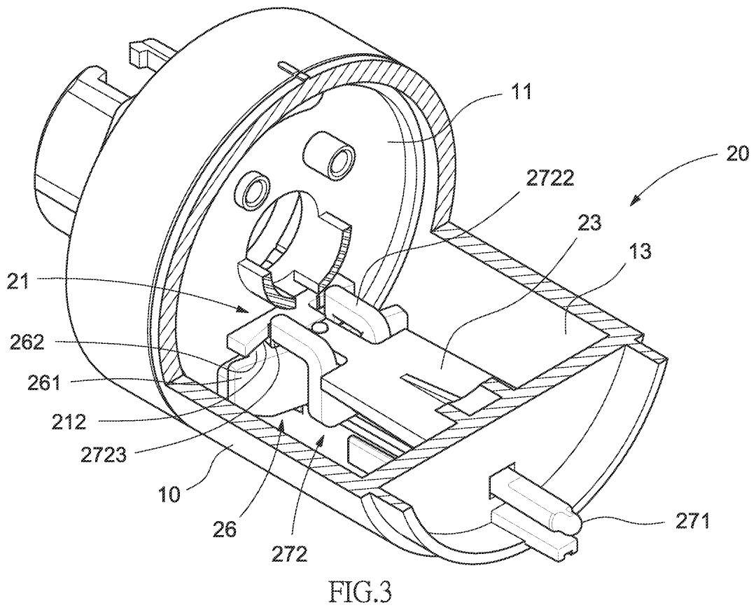

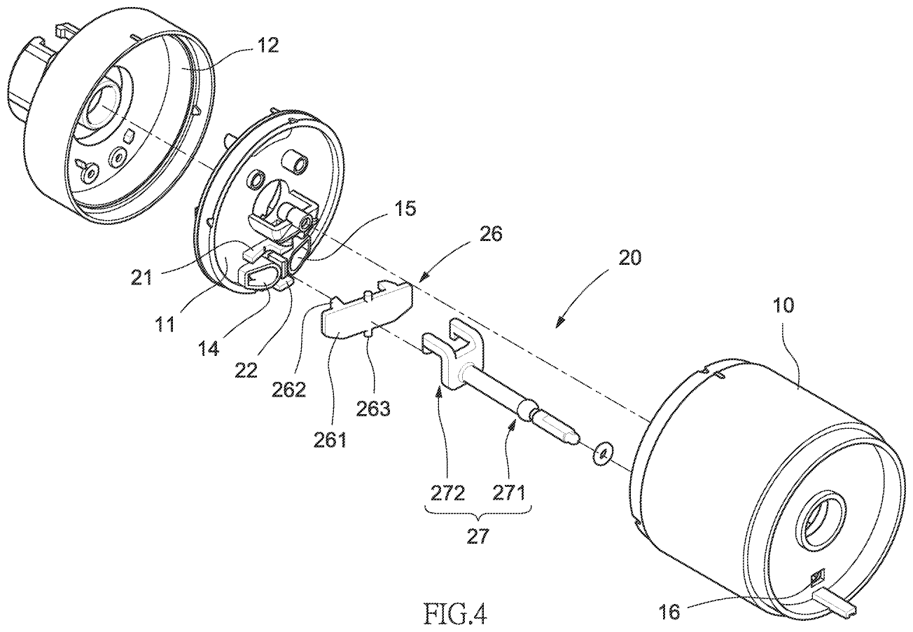

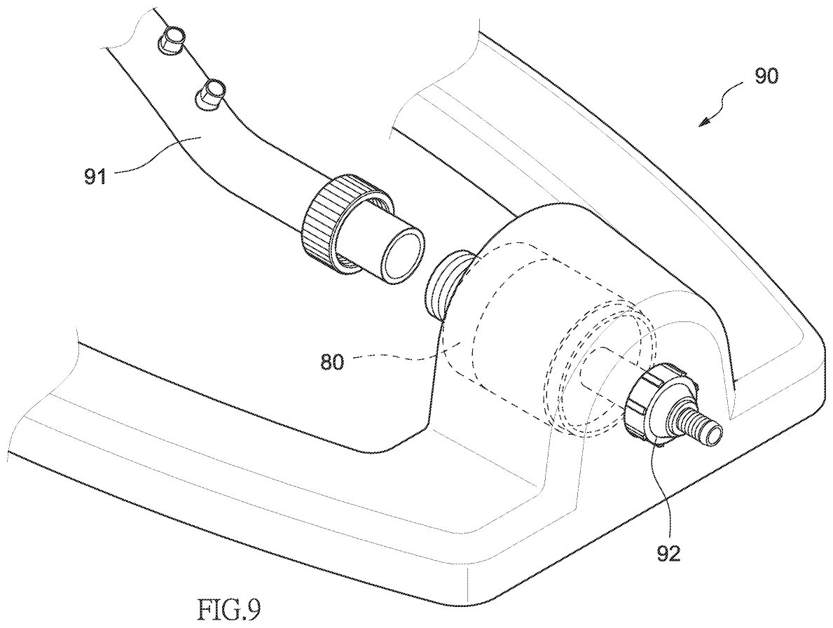

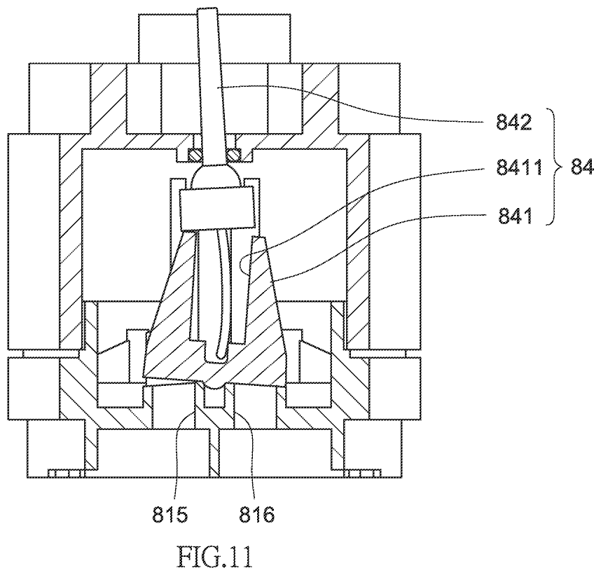

Referring to FIGS. 1 to 7, a nozzle-swinging apparatus is devised according to the preferred embodiment of the present invention. The nozzle-swinging apparatus of the present invention can be used in the sprinkler 90 described above in the RELATED PRIOR ART referring to FIGS. 9 through 11. The nozzle-swinging apparatus of the present invention is identical to the nozzle-swinging apparatus 80 described in the RELATED PRIOR ART referring to FIGS. 9 through 11 except for including a different movable base 10 and a different current-switching unit 20.

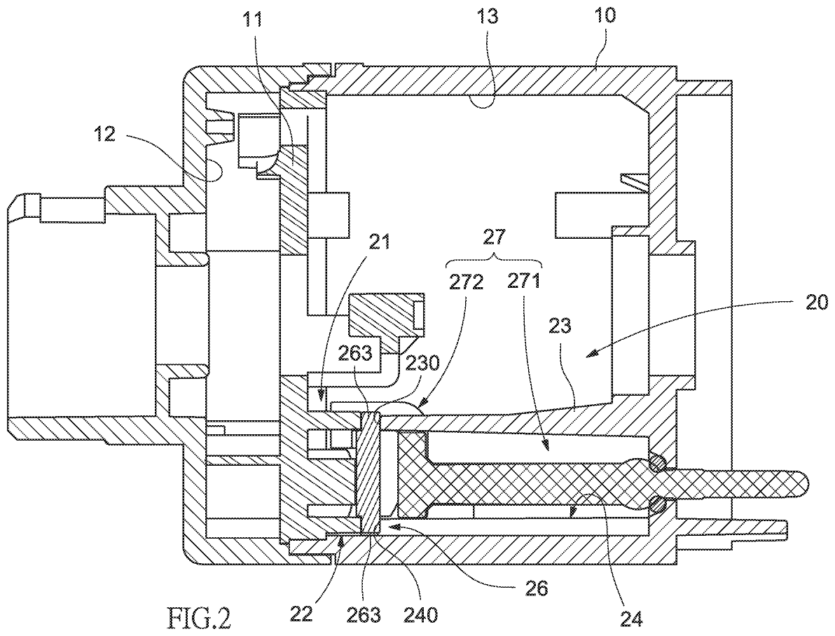

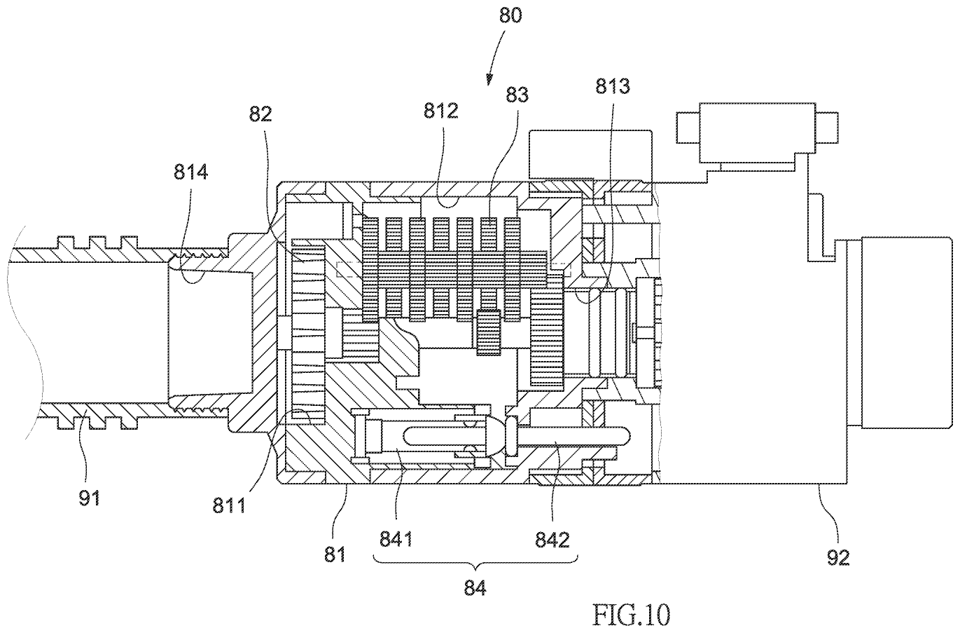

Referring to FIGS. 2, 3 and 5, the movable base 10 is a hollow element including a partition 11 extending between two chambers 12 and 13. The partition 11 is formed with two channels 14 and 15 through each of which the chamber 12 is in communication with the chamber 13. The chamber 12 contains a leafed wheel 82 and the chamber 13 contains a gear train 83 (FIG. 10).

The current-switching unit 20 includes two tabs 21 and 22, two connectors 23 and 24, a sharp protuberance 25, a valve 26, and a switch 27. The tabs 21 and 22 extend from a face of the partition 11 in the chamber 13. The channels 14 and 15 are located between the tabs 21 and 22. The tab 21 includes a supporting face 211 extending between two recesses 212. The tab 22 includes a supporting face 221 extending a same plane with the supporting face 211.

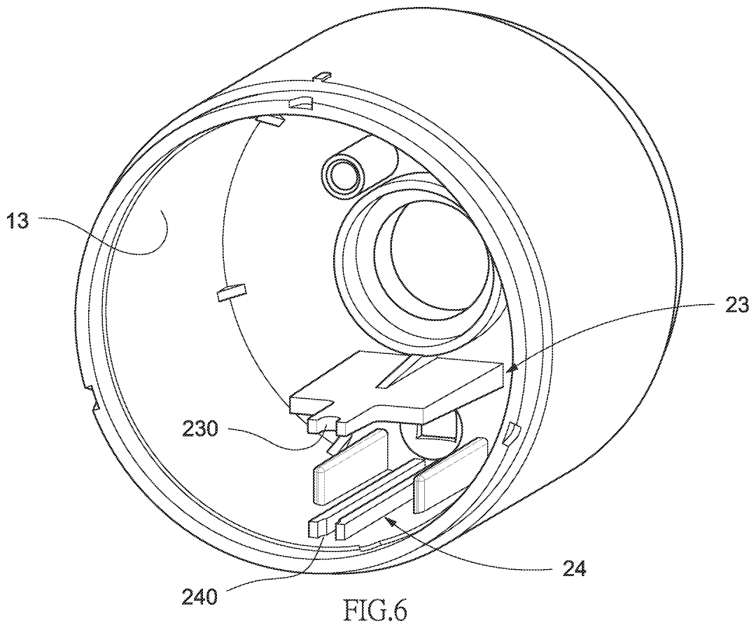

Referring to FIG. 6, the connectors 23 and 24 extends from a wall of the chamber 13. The connector 23 includes a cutout 230 in a free end. The connector 24 includes a cutout 240 in a free end.

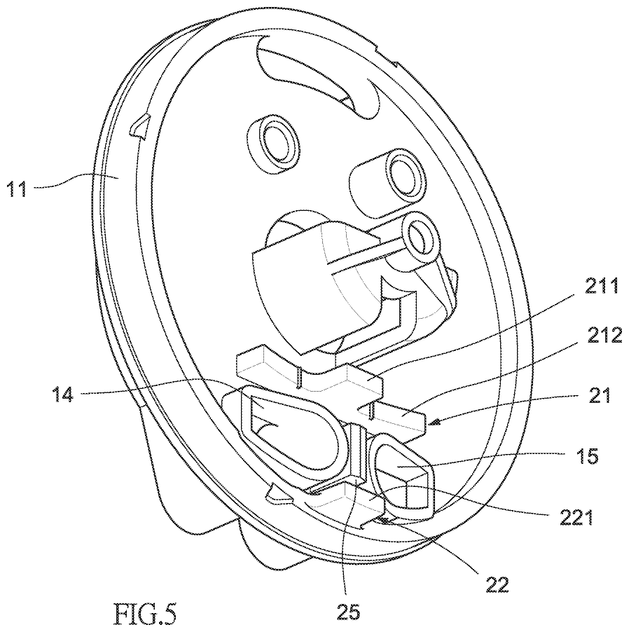

Referring to FIG. 5, the sharp protuberance 25 extends from the face of the partition 11. The sharp protuberance 25 extends between the channels 14 and 15 in a horizontal sense of direction. The sharp protuberance 25 extends between the tabs 21 and 22 in a vertical sense of direction. The sharp protuberance 25 includes two inclined faces pointed at the channels 14 and 15, respectively.

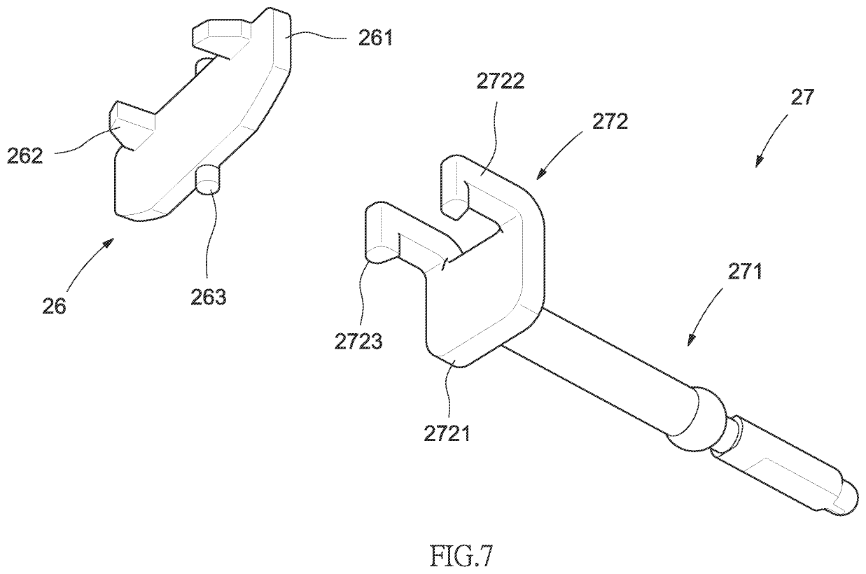

Referring to FIG. 7, the valve 26 includes a membrane 261, two extensions 262 extending from a side of the membrane 261, and two pivots 263 extending from two opposite edges of the membrane 261. The pivots 263 extend along a same axis that extends perpendicular to a plane in which the extensions 262 extend. The membrane 261 includes two halves on two opposite sides of the axis along which the pivots 263 extend.

The switch 27 includes a lever 271 and a valve-moving element 272. The valve-moving element 272 is formed with a plate 2721, two cantilevers 2722 and two rods 2723. The cantilevers 2722 extend from a face of the plate 2721. Each of the rods 2723 perpendicularly extends from a corresponding one of the cantilevers 2722. The lever 271 extends from another face of the plate 2721.

Referring to FIGS. 2 to 4, the partition 11 is located in the movable base 10 so that the connectors 23 and 24 are aligned with the tabs 21 and 22, respectively. One of the pivots 263 is inserted in the recess 230 closed by the tab 21. The other one of the pivots 263 is inserted in the recess 240 closed by the tab 22. Thus, the valve 26 is pivotally located in the movable base 10 by the connectors 23 and 24 and the tabs 21 and 22.

The lever 271 includes a first section extending out of the chamber 13 through a slot 16 made in the wall of the chamber 13. The lever 271 includes a second section extending in the chamber 13, between the connectors 23 and 24. The cantilevers 2722 extend above the membrane 261. The rods 2723 extend between the extensions 262, in the recesses 212. Each of the halves of the membrane 261 is located between the plate 2721 and a corresponding one of the rods 2723.

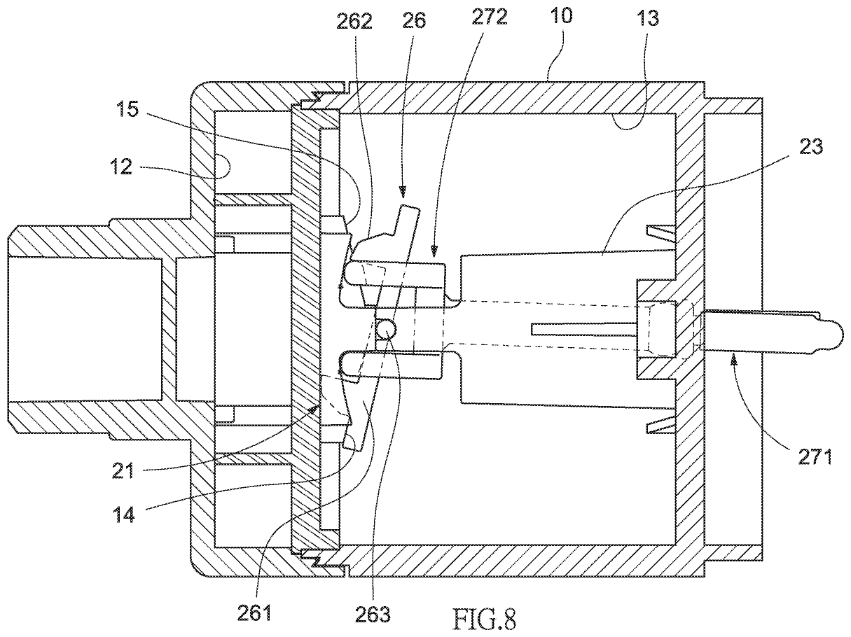

Referring to FIGS. 1 to 9, an end of the movable base 10 is connected to the nozzle 91 and another end of the movable base 10 is connected to the joint 92. In use, the joint 92 is connected to a source via a hose so that a current of water enters the chamber 13 from the source. The first section of the lever 271 is operable to pivot the second section of the lever 271 so that the valve-moving element 272 moves the membrane 261 of the valve 26.

For example, as shown, the lever 271 is pivoted to a position by the first section. Thus, the valve-moving element 272 is moved to a position where one of the rods 2723 abuts one of the extensions 262 to cause one of the halves of the membrane 261 to close the channel 14 so that the current of water is admitted into the chamber 12 from the chamber 13 through the channel 15.

Alternatively, although shown, the lever 271 can be pivoted to another position by the first section. Thus, the valve-moving element 272 is moved to another position where the remaining one of the rods 2723 abuts the remaining one of the extensions 262 to cause the remaining one of the halves of the membrane 261 to close the channel 15 so that the current of water is admitted into the chamber 12 from the chamber 13 through the channel 14.

The present invention has been described via illustration of the preferred embodiment. Those skilled in the art can derive variations from the preferred embodiment without departing from the scope of the present invention. Therefore, the preferred embodiment shall not limit the scope of the present invention defined in the claims.

1. A nozzle-swinging apparatus of a sprinkler comprising:
a movable base located in the sprinkler and comprising a first chamber for containing a leafed wheel, a second chamber for containing a gear train, and a partition extending between the first and second chambers and comprising two channels via which the first chambers is in communication with the second chamber;
a current-switching unit comprising:
a first tab extending from the partition in the second chamber;
a second tab extending from the partition in the second chamber;
a first connector extending toward the first tab in the second chamber;
a second connector extending toward the second tab in the second chamber;
a valve comprising:
a first pivot extending in a gap between the first tab and the first connector; and
a second pivot extending in a gap between the second tab and the second connector; and
a switch comprising:
a lever comprising a first section extending out of the movable base and a second section extending in the movable base; and
a valve-moving element for grabbing the valve, wherein the first section of the lever is operable to pivot the second section of the lever so that the valve-moving element causes the valve to close one of the channels.

2. The nozzle-swinging apparatus according to claim 1, wherein each of the first and second connectors comprises a cutout for containing a corresponding one of the first and second pivots.

3. The nozzle-swinging apparatus according to claim 1, wherein the valve comprises two extensions, wherein the valve-moving element comprises a plate and two rods extending from the plate, wherein the one of the rods selectively abuts against one of the extensions so that the valve-moving element moves the valve.

4. The nozzle-swinging apparatus according to claim 3, wherein the valve-moving element comprises two cantilevers extending from the plate, wherein each of the rods extending from a corresponding one of the cantilevers.

5. The nozzle-swinging apparatus according to claim 4, wherein the valve is located between the plate and the rods.

6. The nozzle-swinging apparatus according to claim 1, wherein the channels are located between the first and second tabs.

7. The nozzle-swinging apparatus according to claim 1, wherein the valve comprises two halves each of which is used to close a corresponding one of the channels.

8. The nozzle-swinging apparatus according to claim 1, wherein the partition comprises a sharp protuberance extending between the channels.

9. The nozzle-swinging apparatus according to claim 8, wherein the sharp protuberance comprises two inclined faces pointed at the channels, respectively.
